(19) United States
(12) Patent Application Publication
(10) Pub. No.: US 2002/0070099 A1
(43) Pub. Date: Jun. 13, 2002

(54) Automated process buffer shuttle

(76) Inventor: Phillip K. Neely, Terre Haute, IN (US)

Correspondence Address: RADER FISHMAN & GRAUER PLLC, LION BUILDING, 1233 20TH STREET N.W., SUITE 501, WASHINGTON, DC, 20036, US

(21) Appl. No.: 09/734,577

(22) Filed: Dec. 13, 2000

(51) Int. Cl. B65G 25/04

(52) U.S. Cl. 198/750.1

(57) ABSTRACT

A shuttle for transferring cargo between a storage area and a manufacturing area has a cargo platform for receiving the cargo along a horizontal transfer path. The shuttle has two telescoping tables, the first controlled by a single servomotor drive mechanism, while the second table is a slave to the first table. When the drive mechanism powered by the servomotor extends the first table, a second passive drive mechanism extends the second table from the first table an equal amount in the same direction. The tables are reversible, and can extend in either longitudinal direction of the shuttle in order to retrieve or replace cargo onto shelves located on either side of the shuttle. Sensors on the shuttle sense the presence of cargo on a shelf, the position of the cargo on the cargo platform, and the location of the tables relative to the shuttle base.

### FIELD OF THE INVENTION

This invention relates generally to an apparatus for automatically transferring a tote between shelving units, and more particularly to a tote shuttle portion of a crane for automatically transferring a tote between warehouse shelving and another transport medium such as a conveyor.

### BACKGROUND

The use of vertical storage devices such as shelving in a warehouse environment is only helpful when one can track what is stored on the shelving and retrieve the stored material in an efficient manner. Different types of shelving storage and retrieval mechanisms have been developed to place cargo onto shelves and to retrieve cargo from a predetermined shelf.

One type of transfer apparatus is known as a running fork device. This device utilizes forks which lift the cargo container up from the shelf and moves the cargo away from its resting shelf location. Operation of this type of device is similar to a fork-lift device. The running fork device can include devices that grip opposing sides of the container and pull the container from the resting shelf location.

In another type running fork device, a hook is integral with the transfer apparatus and is used to hook onto a loop on the container. In this manner, the hook is used to catch the container and pull the container from the resting shelf location.

In fork-lift type devices, the containers must rest on shelving such that a space remains below the container for the forks to enter below the container and above the shelf. Leaving this additional space below the container reduces the amount of available vertical storage area. See for example U.S. Pat. No. 5,207,555.

Side-grip type devices require clearance on the sides of the container, thereby reducing the amount of horizontal storage area on the shelving.

Hook and loop type devices are limited to containers having compatible loops, limiting their use and increasing cost for custom containers.

Another device for transferring containers from warehouse shelving involves the use of a cargo platform. Integrated with a crane-type device, the cargo platform extends from a base, slides below the container and frictionally engages the underside of the container. The cargo platform is driven by one motor in one direction, and a second motor in the opposite direction. Typically, the cargo platform employs rack and pinion gears to extend the platform from the neutral, or center position of the base. Additionally, the platform is supported and guided with cam following bearings riding in custom-machined slots. Control of the cargo platform is typically through the use of multiple roller switches that often require adjustment due to wear. See for example U.S. Pat. No. 5, 839,872.

However, the prior art devices are heavy, use complicated combinations of parts, are costly to fabricate and maintain, and are unable to perform precision handling of the actual cargo.

Consequently, there is a need for an apparatus and method for transferring containers from warehouse shelving having varying widths using a device that uses fewer parts, is lighter, lest costly to fabricate and maintain, and easier to adjust for precision handling.

### SUMMARY OF THE INVENTION

An object of the present invention is an improved apparatus for the transfer of cargo or totes containing cargo.

Another object of the present invention is an improved apparatus for the transfer of cargo or totes containing cargo from a rack storage system.

The present invention is directed to a cargo transfer apparatus, or shuttle. The shuttle is used in an automated process buffer for the storage and retrieval of totes or containers from a matrix of shelf locations. The shuttle has a rigid cargo platform that can extend towards one side or the opposing side. The ability to extend in either diametrically opposite direction allows for retrieval of totes stored on either side of the shuttle centerline. The shuttle is moved within the automated process buffer by a crane.

The shuttle consists of a rigid frame and mount system that supports two tables that telescope out from the frame in either of the two opposing directions using a single motor and multiple chain drive system. The top table is fitted with a flat tooling plate that the payload sits directly upon.

Totes are transferred from the shelf to the top table by first telescopically extending the top table and the middle table from the frame assembly towards the shelf. The top table, positioned parallel and beneath the tote, is extended into the shelf matrix and under the tote. The shuttle is moved slightly upward, thereby moving the top table upward and lifting the tote from the shelf upon which the tote was resting. The top table frictionally engages the tote. Retraction of the middle table and the top table withdraws the tote from the shelf matrix for transport to another location, friction between the bottom of the tote and the top table allows the tote to maintain contact with the top table as the tote is withdrawn from the shelf matrix. Lifting the tote eliminates the friction between the tote bottom and the shelf that would resist the tote from being withdrawn from the shelf matrix.

When a tote is returned from the shuttle to the shelf matrix, the process is reversed, whereby the shuttle is positioned such that when the top table is telescopically extended, the bottom of the tote is above the resting position on the shelf. When the top table is lowered, the tote rests on the shelf matrix, contact with the top table is terminated, and the shuttle can be retracted and withdrawn without the tote.

The shuttle uses one motor to extend the tables in either of the two opposing directions, using a single chain and sprocket drive system. “V” bearings and matching hardened rails are used to support and guide the top table.

Control of the shuttle movements is performed with the use of a servomotor, allowing adjustments to be made with software. In this manner, precise adjustments can be made, and results in “set and forget” adjustments.

Sensors are variously located throughout the shuttle. The middle table has a home sensor and a set of extend sensors. The home sensor defines where the neutral or home position is. The home position is when the top table, and by default the middle table, are approximately centered in the frame. The extend sensors are positioned such that when neither sensor is tripped, the top table is centered. As the top table moves in one direction or the other, the corresponding extend sensor will be tripped. This information, when input to the control system, determines which direction the tables must be driven to return them to the neutral position. These sensors can also be used as interlock to the other axes of motion. For example, if the shuttle is extending in either direction or becomes disabled in an extended position, all other axes of motion are disabled. That is, the shuttle and/or the crane will be prevented from moving in a manner that could damage the shuttle, the tote, the cargo or the shelving by moving up, down, towards or away from the shelving.

The shuttle also uses sensors for tote detection. For example, a diffuse sensor located at each end of the shuttle verifies tote presence or absence in the shelf matrix being serviced. This sensor first scans the position where a tote is expected, and the information is sent to the control system.

Movement of a tote can occur for various reasons, including, but not limited too, delivery of the tote and cargo to another manufacturing location, intermediate storage of the cargo between manufacturing or shipping processes, and consolidation of the cargo.

It will be apparent that the shuttle of the present invention is adapted to be incorporated in a cargo transfer unit, also known as a transporter or crane, that is movable along racks of shelving.

These and other features and advantages of this invention are described in or are apparent from the following detailed description of the preferred embodiments.

### BRIEF DESCRIPTION OF THE DRAWINGS

The preferred embodiments of this invention will be described in detail, with reference to the following figures, wherein:

FIG. 1 is a perspective view of a tote shuttle of this invention in an extended position;

FIG. 2 is an exploded perspective view of the shuttle detailing the tables, rails and bearings;

FIG. 2A is a close-up perspective view of a bearing and rail;

FIG. 3 is a partially exploded perspective view of the main drive;

FIG. 4 is an exploded perspective view of the secondary drive;

FIG. 5 is a perspective view depicting the stops and table sensors;

FIG. 6 is a perspective view depicting the tote sensors;

FIG. 7 is a perspective view of a tote shuttle integrated with a shuttle carrier in a shelf matrix;

FIG. 8 is a perspective view of a tote alongside the shelf matrix;

FIG. 9 is a perspective of a tote resting on a top table of a shuttle;

FIG. 10 is a perspective view of a tote resting on a shuttle being transported;

FIG. 11 is a perspective view of a tote extended into a shelf matrix by a shuttle; and

FIG. 12 is a perspective view of a tote resting on a shelf in a shelf matrix.

### DETAILED DESCRIPTION OF THE PREFERRED EMBODIMENT

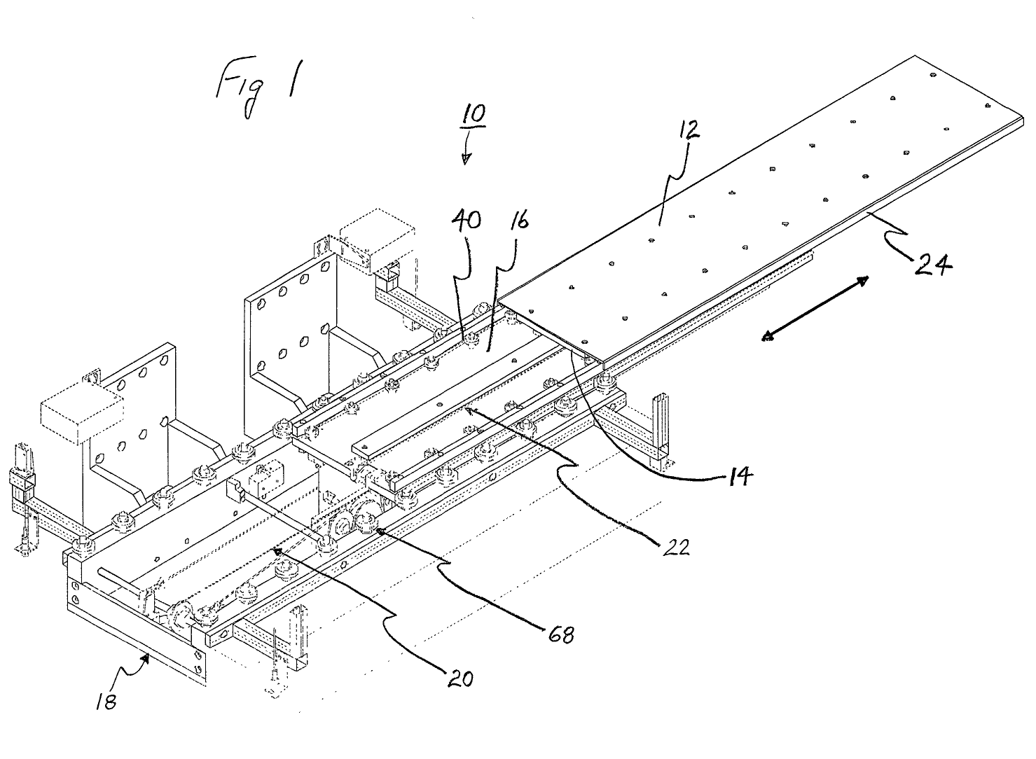

FIGS. 1-6 depict various details of the shuttle 10 of this invention. The shuttle 10 has a top 12 attached to a first table 14. The first table 14 is movably attached to a second table 16. The second table 16 is removably attached to a frame assembly 18. A primary drive mechanism 20 and a secondary drive mechanism 22 drive the first and second tables 14, 16 in a telescoping manner.

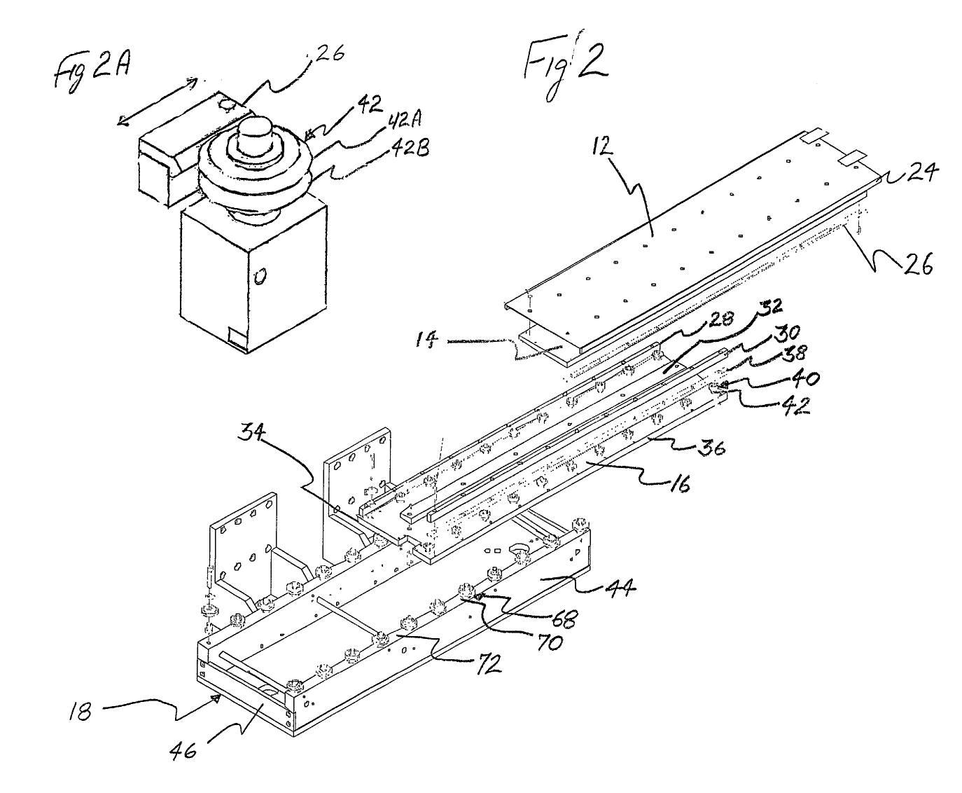

The top 12 shown in FIGS. 1-2 is a generally flat rectangular top that mounts to the first table 14, and is preferably fabricated from stainless steel. Alternatively, the top 12 can be fabricated from any suitable material, such as steel, aluminum, or various metal-alloys such as brass, wood, and plastic. The choice of material for the table top can vary with cost, wear, ability to frictionally retain a tote or other container, and the ability of the material to withstand ambient environmental conditions such as humidity, temperature, corrosive gases and particulates. The bottom side of top 12 can be either permanently attached to the topside of the first table 14, for example, by welding, riveting or adhesive, or removably attached, for example, by bolting or other mechanical attachment. When top 12 is a metal or other deformable material, side edges 24 of the top 12 can be folded over for stiffness. When the top 12 is a plastic or other moldable material, side edges 24 can be formed with integral stiffening members. Additional stiffening ribs can also be formed which can be integral with or otherwise attached to the top 12.

The first table 14 shown in FIGS. 1-2 is a generally rectangular table smaller than the top 12, and is preferably fabricated from stainless steel or aluminum. Alternatively, first table 14 can be fabricated from any suitable material discussed above regarding the top 12. A first track 26 is attached to the underside of the first table 14 along each longitudinal axis near the perimeter using methods known in the art. These two pieces of first track 26 allow the top 12 and first table 14 combination to glide along the second table 16.

The second table 16 shown in FIG. 2 is a generally rectangular table approximately the same size as the top 12, and is preferably fabricated from stainless steel or aluminum. Alternatively, second table 16 can be fabricated from any suitable material discussed above regarding the top 12. Three stiffener rails 28, 30, 32 are attached to the second table 16 in a generally longitudinal direction to reduce deflection of the table under load. Rail 32 is attached to the table 16 approximately longitudinally along the centerline, while the other two rails 28, 30 are attached near the second table longitudinal edges 34, 36. Between the two rails 28, 30 and the second table 16 are second tracks 38. Along each of the inside edges of the two rails 28, 30 is a first series of bearings 40 attached to the second table 16.

Each of the first tracks 26 interacts with a first series of bearings 40. In the preferred embodiment, the first series of bearings, or guide wheels 40 are steel sealed guide wheels 42 arranged longitudinally along the top surface of the second table 16. Shown in FIG. 2A, each of the wheels 42 has a fixed center, a concentric guide wheel 42A and an adjustable, eccentric guide wheel 42B. Each guide wheel 42 is adjustable. In the preferred embodiment, normal adjustment is obtained by rotating the eccentric guide wheel until the eccentric guide wheel can just be turned against the track 26. If the eccentric guide wheel is overtightened it can exert a force greater than the load rating of the guide wheel. Thus, when adjusted properly, when the track 26 moves, the guide wheels turn, and the first table 14 glides along the top of the second table 16.

Frame assembly 18 shown in FIGS. 1-2 is fabricated from two longitudinal side walls 44, two lateral side walls 46 and a base 48. The primary drive mechanism 20 is mounted on the base 48. A second series of bearings, or sealed guide wheels 68 are attached to the top edge 72 of the longitudinal side walls 44. Each of the second tracks 38 interacts with the second series of guide wheels 68. In the preferred embodiment, the second series of guide wheels 68 are steel sealed guide wheels 70 similar to the first series 40. When adjusted properly, the second table glides along the frame assembly 18 in a manner similar to the first table 14 gliding along the second table 16.

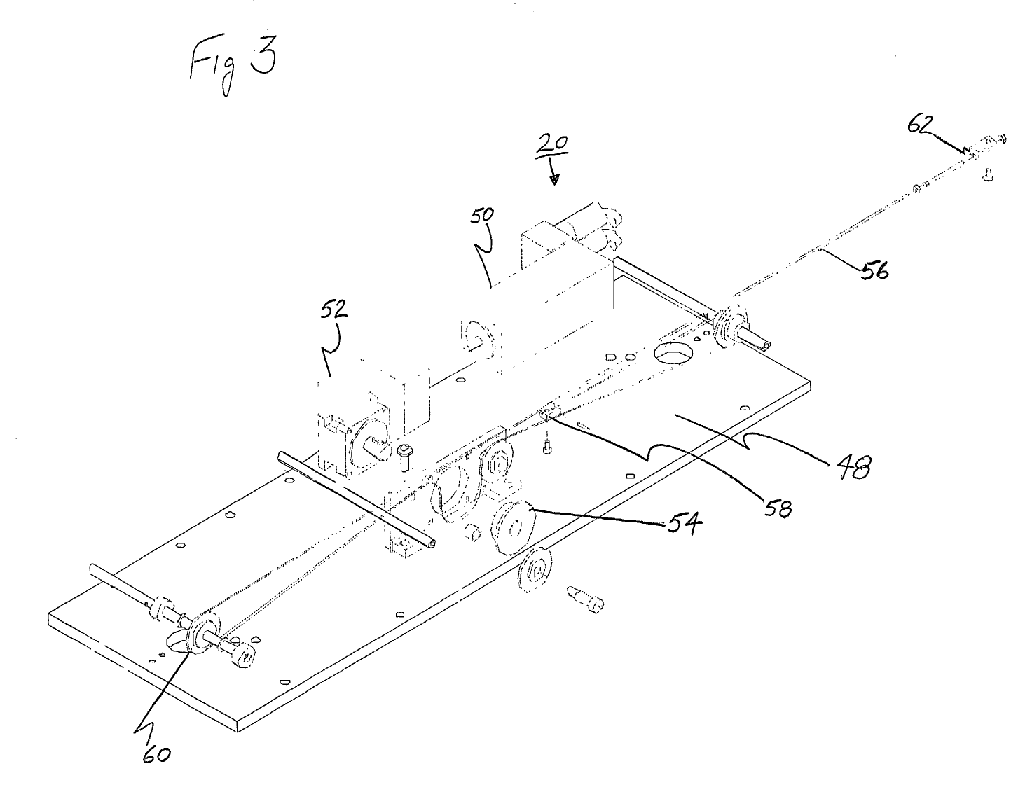

The primary drive mechanism 20 shown in FIG. 3 consists of a servomotor 50 connected to a gearhead 52. The gearhead 52 is connected to a sprocket 54 which moves the first drive chain 56. One end of the first drive chain 56 is mounted to the underside of the second table 16 at a fixed chain mount 58. The first drive chain 56 is routed around an idler 60, and the other end of the first drive chain is attached to an adjustable chain mount 62. The adjustable chain mount 62 is attached to the underside of the second table 16.

As the motor 50 runs, the second table 16 moves in the appropriate direction. When the motor 50 is reversed, the second table 16 moves in the opposite direction. Under normal conditions, the second table 16 will be centered in the frame assembly 18. When the motor 50 is operating, it will drive the second table 16 a desired distance from its neutral position in the desired direction. The motor 50 then stops, reverses direction, and the second table 16 is driven back to its neutral position.

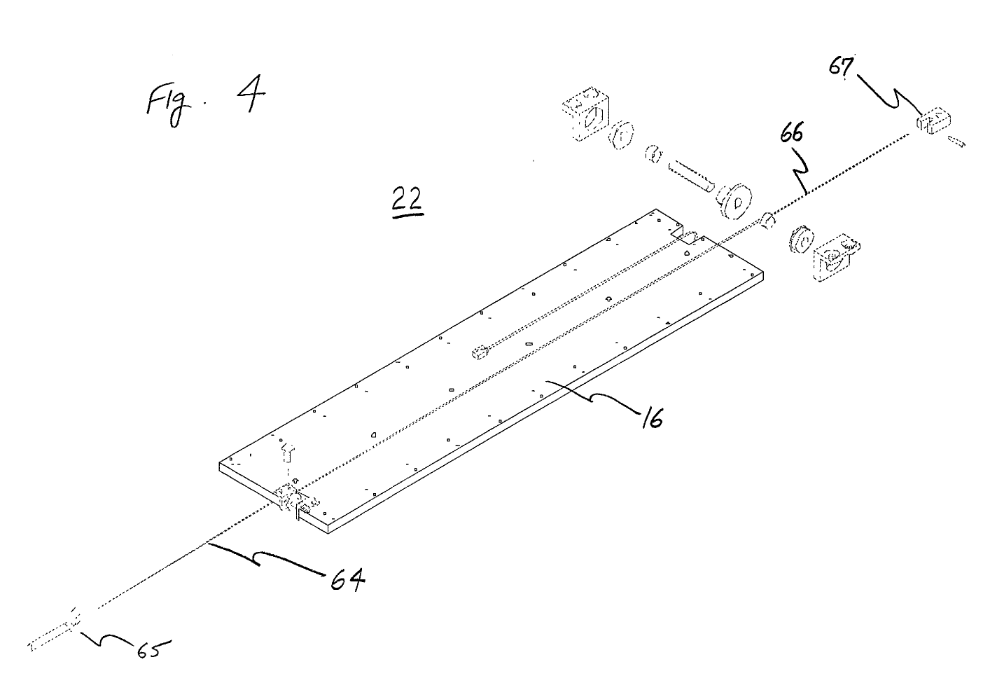

The secondary drive mechanism 22 shown in FIGS. 1 and 4 uses a second drive chain 64 and a third drive chain 66 to move the first table 14 relative to the second table 16. One end of each of the second and third drive chains 64, 66 is fixedly attached to the frame assembly 18 using mount 65. The other end of each of the second and third drive chains is attached to the underside of the first table 14 using mount 67. In this manner, as the second table 16 begins to move, it pulls against both the second drive chain 64 and the third drive chain 66 which moves the first table 14 an equal distance relative to the second table 16 and in the same direction. For example, as the second table 16 moves one inch from the frame 18, the first table 14 will move out one inch, resulting in a two-inch change in overall distance moved from the frame 18. This telescoping action allows the shuttle 10 to reach farther than the length of the shuttle. Additionally, it also allows the load placed on the top 12 to be distributed over several first series bearings 40 and second series bearings 68.

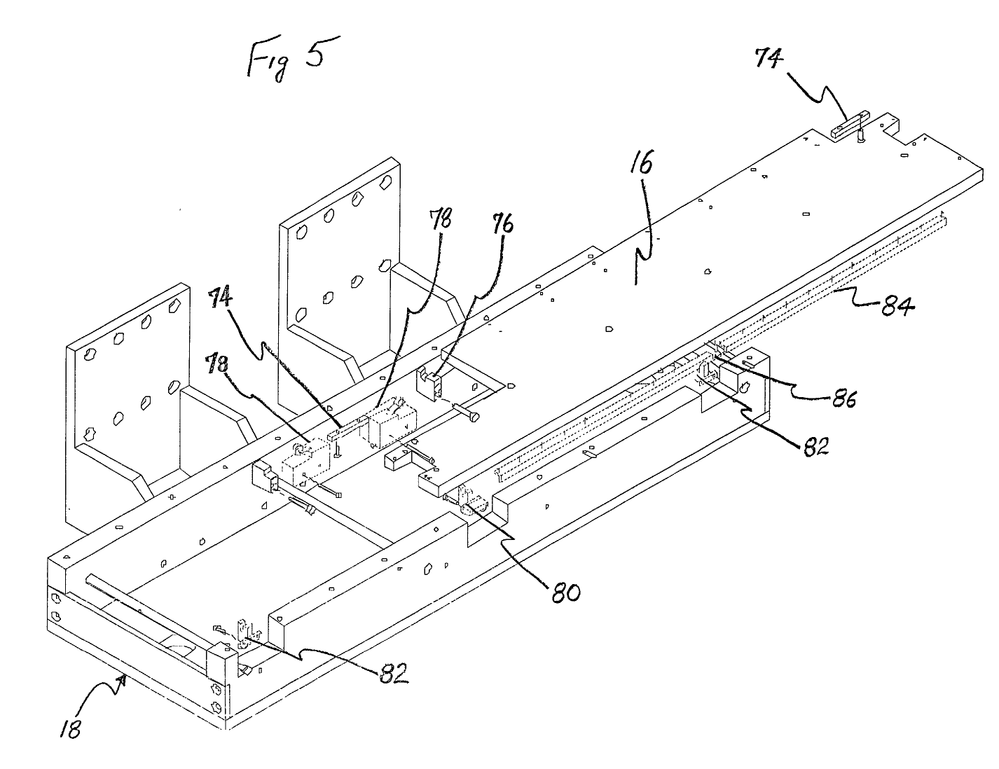

Mounted at both ends and to the underside of the second table 16 are hard stops 74, as shown in FIG. 5. These stops 74 are mounted so that a predetermined stroke, or distance traveled, can be reached. Stop block 76 is mounted to the frame assembly 18 to catch the hard stops 74 and prevent the table 16 from exceeding the preset stroke distance. The hard stops 74 and the stop block 76 are positioned such that the table 16 can move in either longitudinal direction without interference. It will be understood that the hard stops 74 are positioned to a predetermined stroke, or distance.

As shown in FIG. 5, a pair of overrun sensors 78 are mounted to the frame assembly 18, and are tripped by the hard stops 74 prior to the hard stops 74 reaching the stop block 76. In this manner, as the table 16 is extended, the trailing hard stop 74 reaches an overrun sensor 78 prior to the trailing hard stop 74 reaching the stop block 76. When the overrun sensor 78 detects a hard stop 74, a signal is sent to the controller to stop movement of the table 16. In the preferred embodiment, the overrun sensors 78 are roller switches.

A sensor rail 84 is mounted to the underside of the second table 16 for detection by the home sensor 80 and the extend sensors 82. The sensor rail 84 is positioned such that each end of the rail is approximately equidistant from the ends of the table 16, and a gap 86 is positioned near the center line of the table 16. A home sensor 80 and a pair of extend sensors 82 are also mounted on the frame assembly 18. The home sensor 80 is used to indicate where the home, neutral, or centered position is. The extend sensors 82 are positioned so that if neither sensor is tripped, then the table 16 is centered. In this manner, when the table 16 is in the home position, the gap 86 is located at the home sensor 80, and the ends of the sensor rail are inside the extend sensors 82. Movement of the table 16 in either direction will trip a corresponding extend sensor 82. The signal from the extend sensor 82 is sent to the controller, and is used to indicate which direction to drive the tables 14, 16 to return to a neutral, or home position. In the preferred embodiment, the home sensor 80 and the extend sensors 82 are photo microswitches.

Additionally, the sensors 80, 82 are used as interlocks to the other axis of motion. In this manner, when the sensors 80, 82 indicate that the table 16 is in an extended position, all other axis of motion of the crane 100 are disabled. For example, when the tables 14, 16 are extended, the crane 100 will be prevented from moving either side to side or up and down.

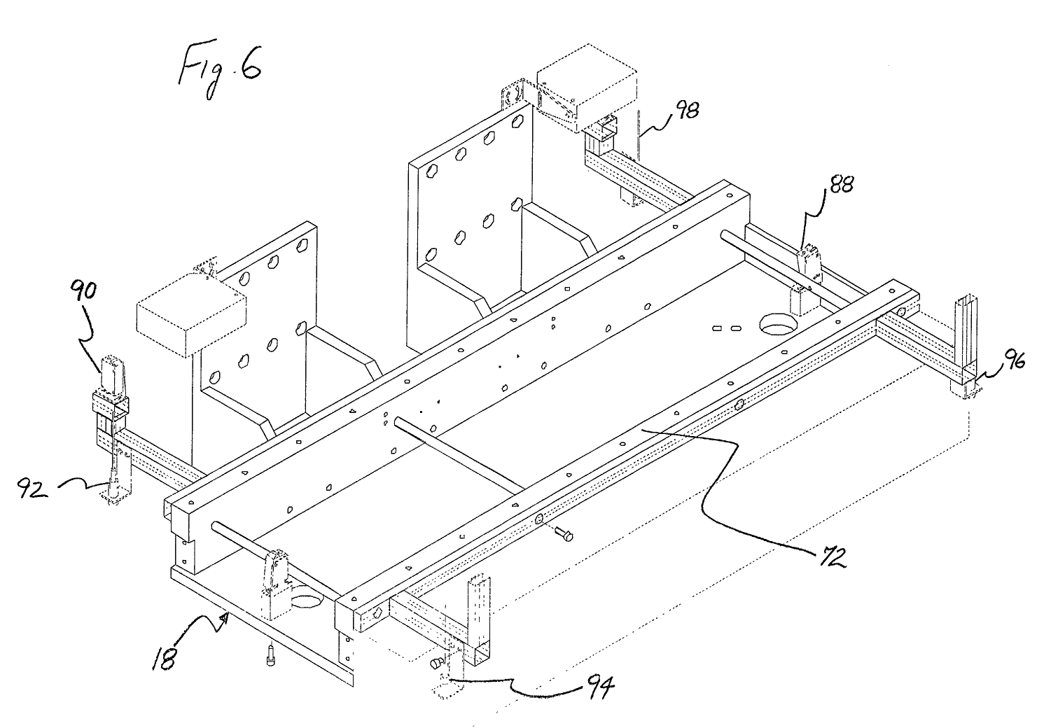

FIG. 6 depicts sensors used for tote detection. A first tote sensor 88 is mounted to both ends of the frame assembly 18. The first tote sensor 88 is used to verify the presence or absence of a tote in the location being serviced. For example, if the shuttle 10 is supposed to extract a tote from a shelf location, the tote detect sensor 88 will scan the position to verify the presence of the tote prior to the shuttle 10 extending the tables 14, 16 to retrieve the tote. Conversely, if the shuttle 10 carrying a tote and is to place the tote, for example, on a conveyor, the first tote sensor 88 will be used to verify that there is no tote presently on the conveyor before the shuttle 10 extends the tables 14, 16 to deliver the tote. In the preferred embodiment, the first tote sensors 88 are diffuse reflective photoelectric sensors.

Two second tote sensors 90 are mounted to the frame assembly 18 positioned to look across the shuttle 10. These second tote sensors 90 are used to verify the presence of a tote on the top 12 and that the tote is centered. For the tote to be considered centered, the shuttle 10 must be in the neutral position and both sensors 90 detecting the tote. In the preferred embodiment, the second tote sensors 90 are retroreflective photoelectric sensors.

Four tactile sensors 92, 94, 96, 98 are mounted near the four corners of the frame assembly 18, and are adjusted to detect the presence of a tote just outside the nominal path of a tote on the top 12. In this manner, if a tote is picked crooked, as the tote is moved onto the shuttle 10, it will trip one of the tactile sensors 92, 94, 96, 98, and a signal will be sent to the controller indicating a non-nominal tote position. In the preferred embodiment, the tactile sensors are short spring wobble stick tactile switches.

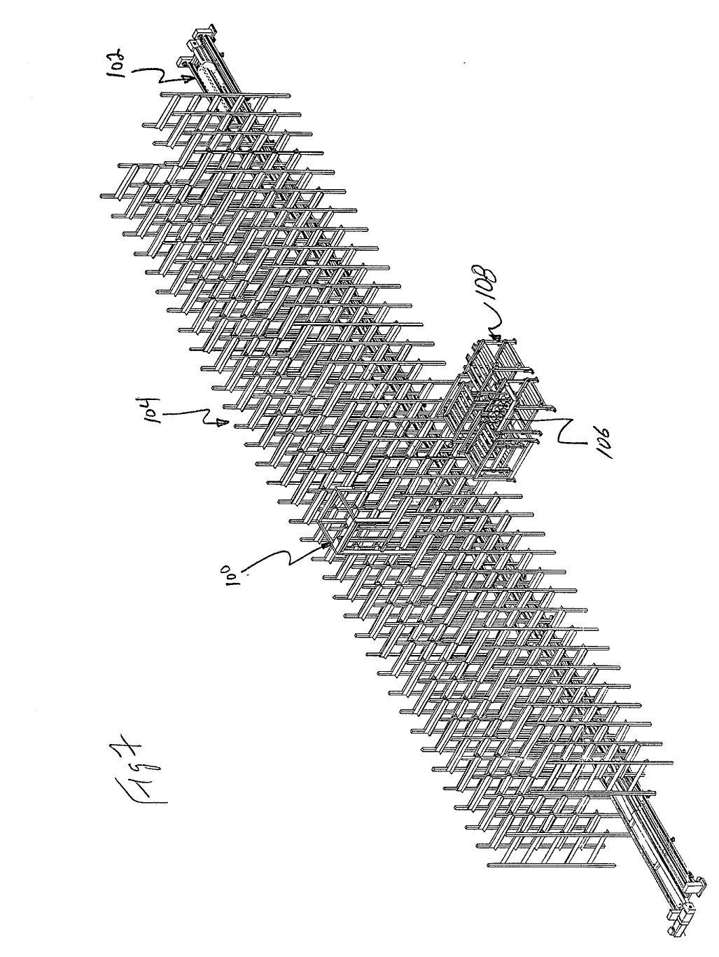

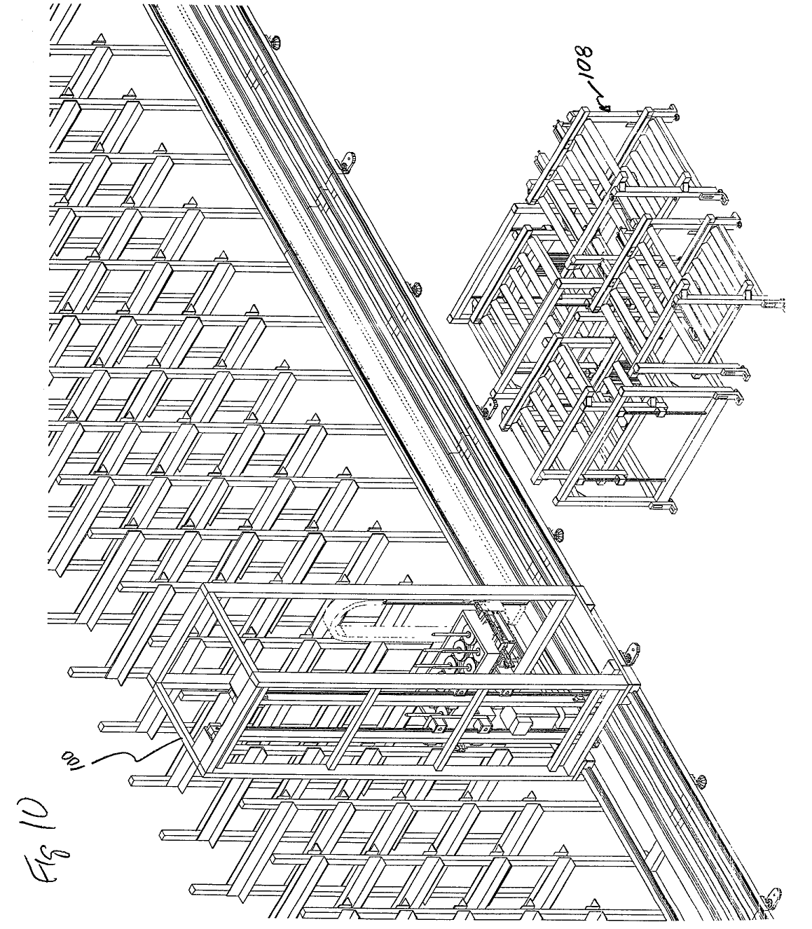

By way of example, FIGS. 7-12 depict perspective views of the tote shuttle 10 moved by a crane assembly 100. The crane assembly 100 moves the shuttle 10 along a rail system 102 among a shelving matrix 104. A tote 106 is on a conveyor 108 awaiting transport to a location in the shelving matrix 104.

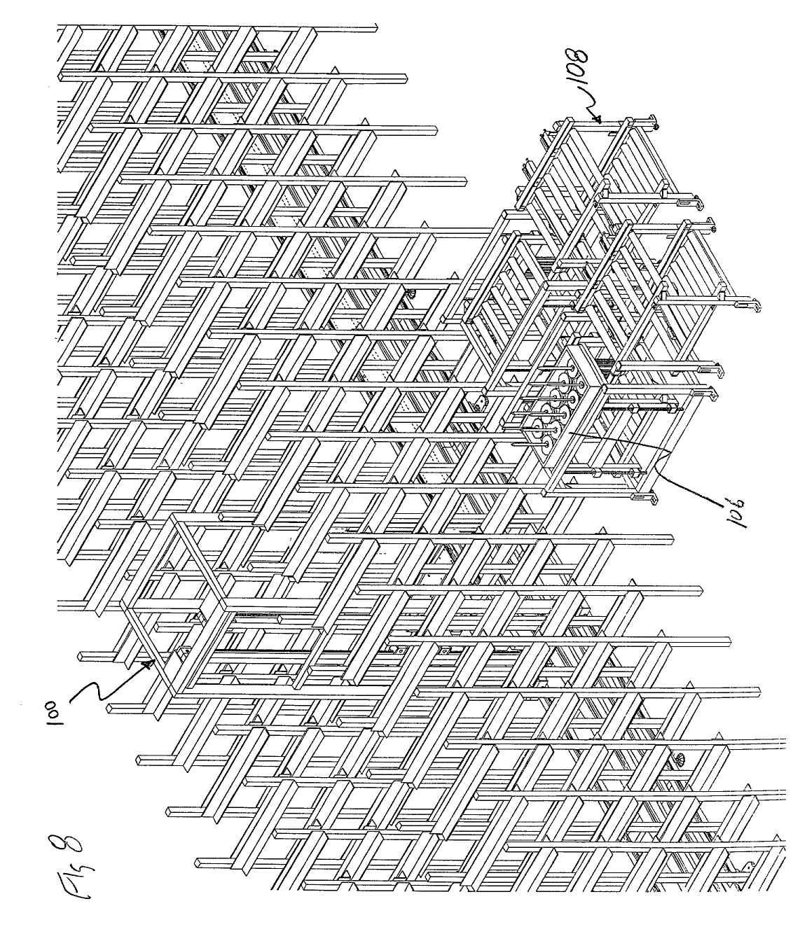

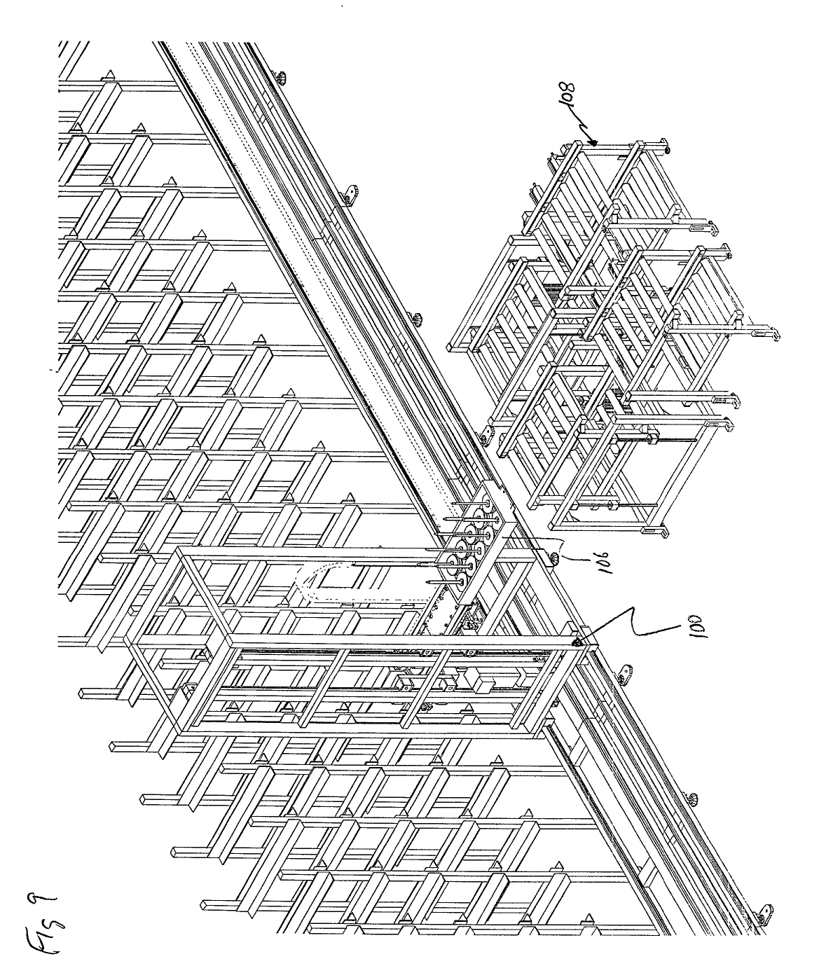

In FIG. 8 tote 106 is placed alongside the shelf matrix 104 for pickup. FIG. 9 depicts the shuttle 10 in an extended position with the tote 106 resting on the top 12. After retraction of the tables 14, 16 to the home position, the tote 106 is centered on the shuttle 10, and the crane 100 moves the shuttle 10 and the tote 106 to a new location.

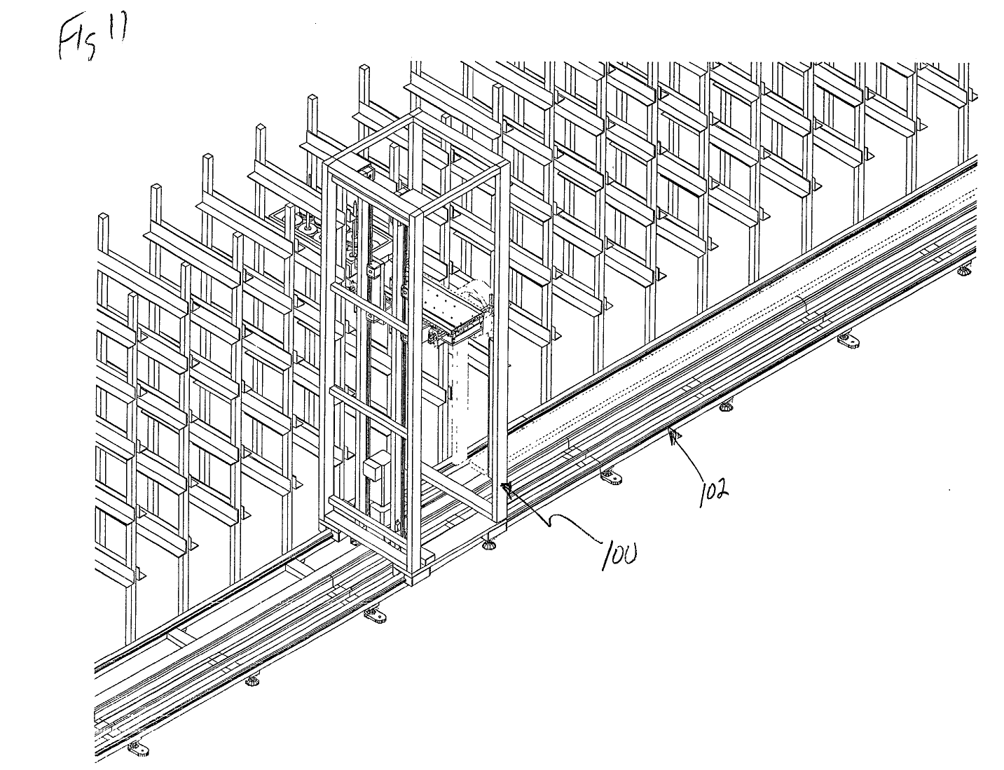

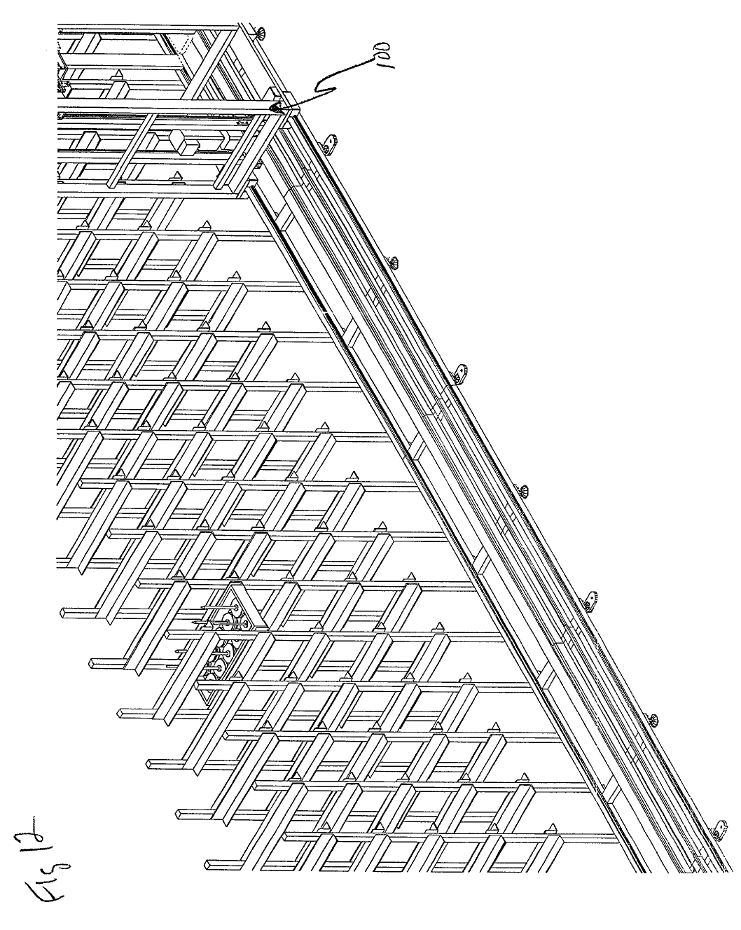

In FIG. 11, the tables 14, 16 are extended and the tote 106 is extended into a shelf in the shelf matrix 104 by the shuttle 10. FIG. 12 depicts the tote 106 resting on a shelf in the shelf matrix 104, the shuttle 10 having retracted the tables 14, 16 to their home position and the crane 100 having moved the along the rail system 102 to another location.

While advantageous embodiments have been chosen to illustrate the invention, it will be understood by those skilled in the art that various changes and modifications can be made therein without departing from the scope of the invention, as defined in the appended claims. For example, an anti-slip coating or a separate anti-slip surface or tape can be applied to the top 12. Various clips, tie-downs, and holders can be attached to the top 12 to aid in retaining a tote in a preferred location, or limiting movement of a tote once it is place in the top 12. Nets or fences can be attached to the top 12 to prevent a tote from falling, or to help direct placement of a tote on the top. Different materials can be used to fabricate the top or the tables as may be appropriate to the work environment, for example, an anti-static top might be beneficial when the tote or unit to be transported can react with an improperly grounded metal surface. Various control systems can be used as is known in the art, and may be operated by various known computers systems. The shuttle 10 can also incorporate a minicomputer for overall control, and a graphical user interface can be incorporated for ease of programming the shuttle.

What is claimed is:

1. A cargo transfer apparatus, comprising:
a cargo platform having a top side and a bottom side for supporting cargo thereon said top side, the cargo being transferred from said platform along a horizontal transfer path between the platform and a shelf;
a first table having a first table top side attached to said cargo platform bottom side and a first table bottom side;
a second table having a second table top side and a second table bottom side, said first table bottom side slideably connected to said second table top side;
a frame having a longitudinal top edge and a base, said second table bottom side slideably connected to said longitudinal top edge;
a motor mounted on said base, said motor driving a first transfer chain connected to said second table;
a second and third driving chains each connected at a first end to said frame and at a second end to said first table;
wherein when said motor moves said first transfer chain, said second table moves in one of two longitudinal directions, and
wherein said first table moves in the same direction as the second table and is displaced from a starting position approximately the same distance as the second table.

2. The cargo transfer apparatus of claim 1, further comprising a sensor that detects whether cargo is present on said shelf.

3. The cargo transfer apparatus of claim 1, further comprising a home sensor that senses when the second table is in a home position.

4. The cargo transfer apparatus of claim 1, further comprising an extend sensor that senses the direction the second table is displaced from a home position.

5. The cargo transfer apparatus of claim 1, further comprising an overrun sensor that senses when said second table is approaching a predetermined maximum extension.

6. The cargo transfer apparatus of claim 1, further comprising a sensor that detects a non-nominal position of the cargo on said cargo platform.

7. The cargo transfer apparatus of claim 1, further comprising a sensor that senses at least one of second table home position, second table direction, approach of maximum predetermined extension of said second table, presence of said cargo on said shelf, and a non-nominal position of said cargo on said cargo platform.

8. The cargo transfer apparatus of claim 7, wherein said sensor is one of a photomicrosensor, a hinge roller lever switch, a photoelectric sensor, a diffuse reflective photoelectric sensor, a retroreflective photoelectric sensor, and a tactile actuator.

9. The cargo transfer apparatus of claim 1, wherein said cargo platform has an anti-slip top surface.

10. The cargo transfer apparatus of claim 1, said apparatus having a centerline, wherein said cargo platform can extend in a first direction or a diametrically opposite direction for retrieval of cargo stored on either side of the centerline.

11. The cargo transfer apparatus of claim 1, wherein said motor is a servomotor.

12. The cargo transfer apparatus of claim 1, further comprising a controller that controls said motor.

13. The cargo transfer apparatus of claim 1, further comprising a hard stop attached to the bottom side of the second table and a stop block attached to the base, wherein said hard stop prevents the second table from extending beyond the stop block.

14. The cargo transfer apparatus of claim 1, wherein movement of said apparatus is controlled by a programmable computer.

15. The cargo transfer apparatus of claim 14, wherein said programmable computer further comprises a graphical user interface.

16. The cargo transfer apparatus of claim 1, wherein said apparatus is a shuttle that is transported by a shuttle transport apparatus.

17. The shuttle transport apparatus of claim 16, wherein said transport apparatus is a crane.

18. The shuttle of claim 16, wherein said transport apparatus travels along a set of tracks, and wherein said tracks are alongside a shelf matrix.

19. The cargo transfer apparatus of claim 1, wherein said shelf is in a shelf matrix.

20. A cargo transfer apparatus, comprising:
a means for supporting cargo and for transferring the cargo from the supporting means along a horizontal transfer path between the supporting means and a shelf;
a means for extending the supporting means along the horizontal transfer path;
a frame for supporting the extending means; and
a motor mounted to the frame for driving the extending means in a longitudinal direction.

21. The cargo transfer apparatus of claim 20, wherein the extending means comprises a first table having a first table top side attached to the cargo supporting means and a first table bottom side; and
a second table having a second table top side and a second table bottom side, the first table bottom side slideably connected to the second table top side.

22. The cargo transfer apparatus of claim 21, further comprising a first transfer chain driven by the motor and connected to the second table;
a second and third driving chains each connected at a first end to the frame and at a second end to the first table;
wherein when the motor moves the first transfer chain, the second table moves in one of two longitudinal directions.

23. The cargo transfer apparatus of claim 22, wherein the first table moves twice as far as the second table in the same direction as the second table.

24. The cargo transfer apparatus of claim 20, further comprising a sensor for detecting whether cargo is present on the shelf.

25. The cargo transfer apparatus of claim 20, further comprising a sensor for detecting when the extending means is in a home position.

26. The cargo transfer apparatus of claim 20, further comprising a sensor for detecting at least one of home position of the extending means, direction of extension of the extending means, presence of cargo on the cargo supporting means, approach of maximum extension of the extending means, and non-nominal position of the cargo on the cargo supporting means.

27. The cargo transfer apparatus of claim 20, the apparatus having a centerline, wherein the extending means can extend in a first direction or a diametrically opposite direction for retrieving cargo stored on either side of the center line.

28. The cargo transfer apparatus of claim 20, further comprising a controller for controlling at least one of motor speed and motor direction.

29. A method for transferring cargo between two locations using a cargo transfer apparatus, comprising the steps of:
receiving a first signal to fetch the cargo from a first predetermined location;
automatically moving the cargo transfer apparatus to the predetermined location;
extending a cargo platform from a home position toward the first predetermined location using a single motor drive mechanism;
sensing if a first cargo is at the first location, wherein if the first cargo is not at the first location, returning the cargo platform to the home position;
retrieving the first cargo from the first location; and
retracting the cargo platform with the first cargo to the home position using the single motor drive mechanism.

30. The method of claim 29, further comprising the steps of:
receiving a second signal containing information on where to move the first cargo; and
automatically moving the cargo transfer apparatus with the first cargo to a second predetermined location.

31. The method of claim 30, further comprising the steps of:
extending the cargo platform containing the first cargo from the home position to the second location;
sensing if a second cargo is at the second location, wherein if the second cargo is not at the second location, placing the first cargo at the second location.

32. The method of claim 31, further comprising the step of retracting the empty cargo platform to the home position using the single motor drive mechanism.
